(19) United States
(12) Patent Application Publication
(10) Pub. No.: US 2003/0227478 A1
(43) Pub. Date: Dec. 11, 2003

(54) Systems and methods for a group directed media experience

(76) Inventor: Keith M. Chatfield, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/164,263

(22) Filed: Jun. 5, 2002

(51) Int. Cl. G09G 5/00

(52) U.S. Cl. 345/751

(57) ABSTRACT

Systems and methods for a media experience directed by a group are disclosed. One method comprises receiving input from a plurality of members of the group regarding a plurality of media content, creating a playlist of media content based at least in part on the received input, and playing the media content in the order in which the media content appear in the playlist.

### TECHNICAL FIELD OF THE INVENTION

The present invention relates generally to the field of digital entertainment, and more particularly to a system and method for a group directed media experience.

### BACKGROUND OF THE INVENTION

Typically in a group setting, for example at a dance club, in a restaurant, at a health club, or at a party, a single person makes decisions as to the type of music being played. For example, in an establishment, such as a dance club, a disc jockey makes decisions regarding music tracks to be played and the order in which the different music tracks are played. The disc jockey makes these decisions based on his/her perception of the likes and dislikes of the patrons of the dance club. Sometimes the disc jockey receives requests for particular music tracks. However, it is difficult for the disc jockey to determine how pervasive the interest for the requested music track is among the group of patrons. Furthermore, the disc jockey is limited in its selection of content to what is available within the dance club. Similar problems exist in other kinds of settings where a group of people get together for entertainment or other purposes.

### SUMMARY OF THE INVENTION

In accordance with an embodiment of the present invention, a method for a media experience directed by a group is disclosed. The method comprises receiving input from a plurality of members of the group regarding a plurality of media content, creating a playlist of media content based at least in part on the received input, and playing the media content in the order in which the media content appear in the playlist.

In accordance with yet another embodiment of the present invention, a media server for a group directed media experience is disclosed. The media server comprises a processing module operable to automatically create a playlist of media content from a plurality of media content based at least in part on selection by a plurality of members of the group, the processing module further operable to play the media content in the playlist.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of an embodiment of a system for group directed media experience in accordance with the present invention;

FIG. 2A is a block diagram of a media server in accordance with an embodiment of the present invention;

FIG. 2B is an elevational view of a media terminal in accordance with an embodiment of the present invention;

FIG. 3 is a flowchart of a method for providing a group directed media experience in accordance with an embodiment of the present invention;

FIG. 4 is a flowchart of a method for registering a voter in accordance with an embodiment of the present invention;

FIG. 5 is a flowchart of a method for accepting nominations from the registered voters in accordance with an embodiment of the present invention;

FIG. 6 is a flowchart of a method for accepting votes for nominated tracks in accordance with an embodiment of the present invention;

FIG. 7 is a flowchart of a method for assigning special effects in accordance with an embodiment of the present invention; and

FIG. 8 is a flowchart of a method for playing media tracks in the order of the playlist in accordance with an embodiment of the present invention.

### DETAILED DESCRIPTION OF THE DRAWINGS

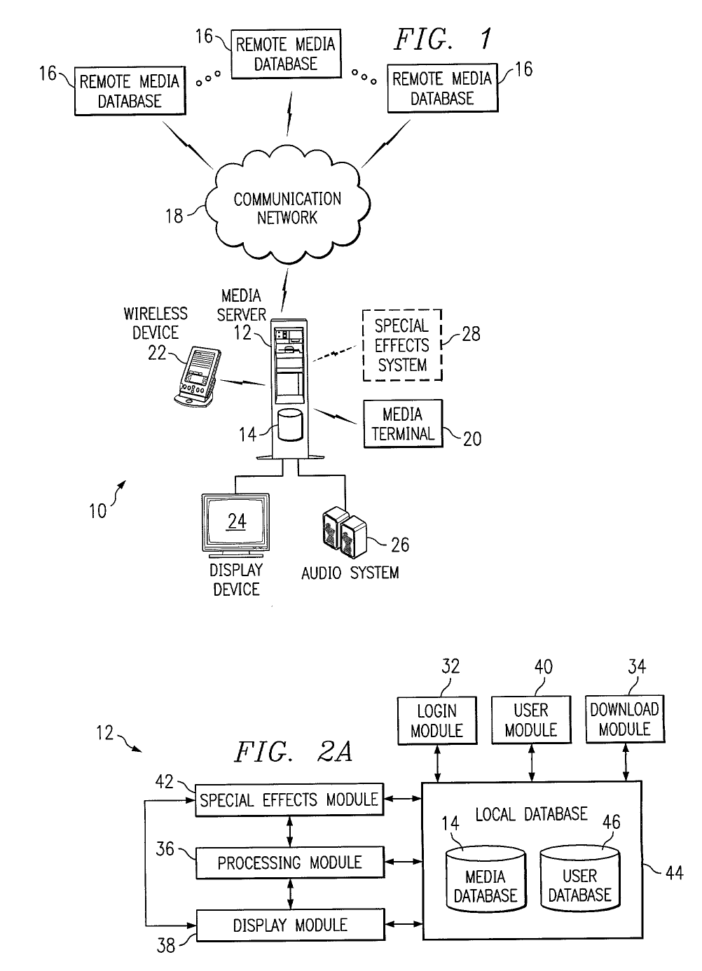

The preferred embodiment of the present invention and its advantages are best understood by referring to FIGS. 1 through 8 of the drawings, like numerals being used for like and corresponding parts of the various drawings.

There is a desire for a group directed media experience. Accordingly, the preferred embodiment system and method generally enables a group of people to control the media experience in an environment by enabling each individual in the group to provide input as to the media content they want to experience. The preferred embodiment system enables each individual who desires to participate to register as a voter, accepts nominations for media content, such as media tracks from the registered voters, displays a list of nominated tracks, enables the registered voters to vote for nominated tracks to be included in a playlist, creates a playlist based on the received votes, displays the playlist, and plays the media tracks based on their order in the playlist.

FIG. 1 is a block diagram of an embodiment of a system 10 for a group directed media experience in accordance with the present invention. System 10 comprises a media server 12 networked with at least one remote media database 16 via a communication network 18. At least one input device, such as at least one media terminal 20 and at least one wireless device 22, may communicate with media server 12. At least one display device 24, such as a monitor, is also preferably coupled to media server 12. An audio system 26 is also preferably coupled to media server 12. If desired, a special effects system 28 may also be coupled to media server 12.

Media server 12 is primarily responsible for collecting and processing input from users of system 10. Media server 12 may be any computing device such as a network computer running a network operating system. Media server 12 preferably comprises a device (not shown) for connecting with a communication network 18, such as a dial-up modem, a cable modem, a wireless modem, a wireless gateway, an X Digital Subscriber Line modem, Integrated Services Digital Network (ISDN) converter, and/or the like. Media server 12 is preferably under the control of a provider of group directed media experience for example a mobile disk jockey, dance club, a bar, a restaurant, a health club, and/or the like. If desired, media server 12 may be under the control of a host of a party.

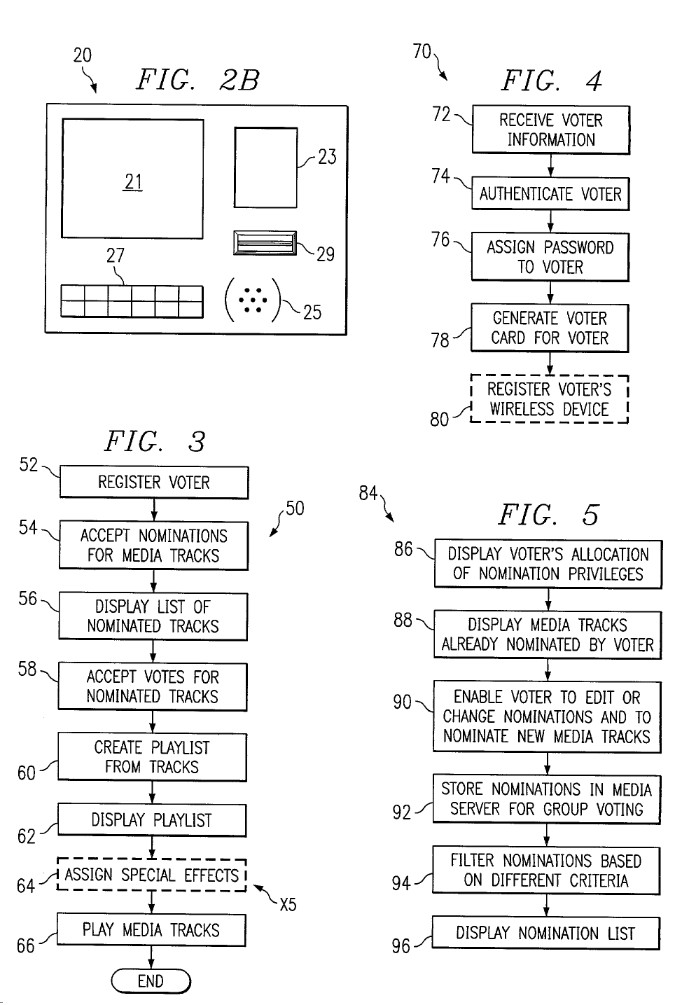

In the preferred embodiment, media server 12 comprises a media database 14. Media database 14 preferably serves as a central repository for media content, such as music, video, games, and/or the like. Remote media databases 16 preferably serve as repositories for media content, such as music, video, games, and/or the like. Remote media databases 16 may be public media databases and/or the users' private collection of media content. If desired, remote media databases 16 may be part of one or more web sites. Preferably, the media content is stored in media database 14 and remote media databases 16 in digital format, such as MP3, wav, mpeg video or other suitable format now known or later developed. An operation and function of media server 12 is described in greater detail herein especially with reference to FIG. 2A.

Communication network 18 preferably comprises a public network, such as the Internet. In alternative embodiments, communication network 18 may comprise any means of information communication, such as a Public Switched Telephone Network (PSTN), a wireless communication network, a proprietary network, a general purpose processor-based information network, dedicated communication lines, a computer network, direct personal computer-to-personal computer connection, a local area network, a wide area network, modem to modem connection, an Intranet, an Extranet, a Virtual Private Network (VPN) or any combination thereof, now known or later developed, suitable for providing data to and from remote media database 16. Thus, if desired, media server 12 may download media content from remote media database(s) 16.

Media terminal(s) 20 may be distributed throughout the establishment to allow users, such as patrons of the provider, to communicate with media server 12. For example, media terminal 20 may be employed by the user to register as a voter, to nominate content in the form of media tracks, to vote for nominated media tracks, to get suggestions on media tracks to be nominated, to access the list of nominated tracks, to access the playlist, to purchase music or video to be delivered to the user over communication network 18, to purchase music or video to be delivered to the user at a later date and/or at a different location over communication network 18 and/or via mail. An operation and function of media terminal 20 is described in greater detail later herein especially with reference to FIG. 2B. Wireless device 22, for example a personal digital assistant (PDA), a wireless phone and/or the like, may also be used by the users to communicate with media server 12 in a similar manner as media terminal(s) 20.

If desired, media server 12 may be networked with other remote databases (not shown) that support transaction processing for media purchases, personal databases to facilitate authentication of the user, or provide other services to make the user aware of other opportunities to enjoy media of interest to the user. For example, at least one remote database may contain information about concerts, pay-per-view events, upcoming music or video releases, media promotions, and/or the like.

Preferably, media server 12 controls the output to audio system 26. Audio system 26 may be a conventional audio system comprising at least speakers. Media server 12 also preferably controls special effects system 28. Special effects system 28 may be used to create fog, create visual effects, adjust lighting and/or the like.

Display device(s) 24 may be distributed throughout the establishment to communicate information or media content to the users. For example, display device(s) 24 may be used to display the list of nominated tracks, to display the playlist, to display video tracks, and/or the like. The displayed video tracks may be video tracks nominated and voted for by the group or video tracks accompanying other media tracks, such as music tracks.

FIG. 2A is a block diagram of media server 12 in accordance with an embodiment of the present invention. Media server 12 comprises a login module 32, a download module 34, a processing module 36, a display module 38, a user module 40, and a special effects module 42, each of these modules being in communication with a local database 44. Preferably, processing module 36 is in communication with display module 38 and special effects module 42. Preferably, display module 38 is also in communication with special effects module 42. The different modules may be implemented in hardware, software or a combination of both.

Local database 44 comprises media database 14 and a user database 46. User database 46 preferably comprises user information, such as user ID, name of the user, password information, user biometric information, user status, email address of the user, last login information, user preferences, user nomination records, user voting records, credit card number for purchases and/or the like. User biometric information may comprise retinal scans, fingerprint information, voice prints, or facial image of the users. User status determines the level of access provided to a particular user. For example, a user with a basic status may be allowed to nominate media tracks only from media database 14, while a user with a premium status may be allowed to nominate media tracks both from media database 14 and from remote media database(s) 16. User preferences may include the user's preferences as to the genre of music, the user's favorite artists, and/or the like. User nomination records may store information regarding prior and current nominations made by the user. Thus, a history of the user's prior nominations during present or prior visits to the establishment may be stored in user database 46 and displayed to the user upon request. User voting records preferably tracks the user's prior and current voting record. Thus, for example, a user who has already voted once during a particular time slot may be prevented from voting again during the same time slot, thereby preventing multiple votes by the same user. Moreover, the user voting record for a particular user may be displayed to the user upon request. If desired, the user's voting record may be used to establish a set of preferences for the user. This set of preferences may be used to suggest media tracks of interest to the user, help the user search for similar media tracks, inform the user about similar media tracks available for purchase, and/or the like.

User module 40 is primarily responsible for managing user information. User module 40 facilitates addition of a user, deletion of a user, updating of user information, and/or the like. User module 40 interacts with user database 46 and updates the information stored in user database 46.

Login module 32 is primarily responsible for providing access to local database 44 to an authorized user. Login module 32 interacts with user database 46 to verify login and other security information provided by the user and also to determine the level of access to be provided to a particular user.

Download module 34 is primarily responsible for enabling the downloading of media and/or other information, such as additional information about particular music tracks, video tracks, games, and/or the like, from databases stored at remote locations, such as for example remote media database(s) 16. Thus, for example, if a media track on the playlist is not available in media database 14, it may be downloaded from remote media database 16. A download log may be maintained, for example to keep track of media that has been downloaded and other download data, such as the date and time of the download. Additional information about particular media tracks may be downloaded in response to a user request for additional information. Such additional information may comprise artist name, ratings, and/or the like.

Processing module 36 is primarily responsible for processing input from the users. Processing module 36 may perform at least one of the following functions: registering a voter, accepting nominations for media tracks from registered voters, creating a list of nominated tracks, accepting votes from registered voters for nominated tracks to be included in the playlist, creating the playlist based on the received votes, and playing the media tracks based on their order in the playlist. If desired, processing module 36 may also allow a user to search for and retrieve information on different media tracks based on search criteria provided by the user, such as name of the artist, type of music, and/or the like. Furthermore, if desired, processing module 36 may control the output to audio system 26.

Display module 38 is primarily responsible for displaying information, such as the list of nominated tracks, the playlist, list of available special effects, and/or the like, on display device 24. Display device 24 may also present information, for example the list of nominated tracks, the playlist, and/or the like, to the user on a screen associated with wireless device 22 or on a screen associated with media terminal 20. Special effects module 42 is primarily responsible for interfacing with and controlling special effects system 28. For example, if the users specify special effects, such as fog, lighting, and/or the like, to be associated with the media content, then special effects module 42 preferably controls special effects system 28 to ensure that the desired special effects are created.

FIG. 2B is an elevational view of media terminal 20 in accordance with an embodiment of the present invention. Media terminal 20 preferably comprises a display 21, a biometric input receiver 23, an audio output device 25, and a card reader 29. If desired, media terminal 20 may be adapted to couple to an external audio output device.

Although it may be any suitable display device, display 21 preferably comprises a Liquid Crystal Display (LCD), and may be used to display text, graphics, images and/or the like. Preferably, display 21 comprises a touch screen with a touch screen keyboard area 27. Display 21 may be used to control various operations of media terminal 20 and/or to enter information to be provided to media server 12.

Biometric input receiver 23 is preferably used to receive biometric information from the user to facilitate authentication of the user. Biometric input receiver 23 may be an audio input device, such as a microphone, which may be used to receive a voice print from the user. In alternative embodiments, biometric input receiver 23 may be a fingerprint scanner which may be used to scan the user's fingerprint, a video camera to capture and receive the user's facial image, a retinal scanner to scan the user's retinal image, and/or the like.

Audio output device 25 is preferably a speaker that may be used to provide audio information to the user. Audio information may include interactive operating instructions, music, and/or the like. If desired, audio output device 25 may comprise a socket into which a head set may be plugged. Audio output device 25 facilitates listening to the options by the user prior to selection.

Card reader 29 is preferably a magnetic card reader that may be used to read credit cards, Automatic Teller Machine (ATM) cards, paper cards with magnetic strips, and/or the like. If desired, card reader 29 may be able to read other types of cards, such as smart cards.

FIG. 3 is a flowchart 50 of a method for providing a group directed media experience in accordance with an embodiment of the present invention. In step 52, media server 12 registers a user as a voter. Preferably in this step voting privileges are also assigned to the voter. A process of registering a voter is described in greater detail herein with reference to FIG. 4. In step 54, media server 12 accepts nominations for media tracks from the registered voters. In step 56, the list of nominated tracks is preferably displayed on display device 24 by media server 12 so that the users may see the media tracks that have been nominated by the different voters to be included in the playlist. If desired, the execution order of steps 54 and 56 may be swapped. The list of nominated tracks may also be displayed on media terminal 20 and/or wireless device 22. A process of accepting nominations from the registered voters is described in greater detail herein with reference to FIG. 5.

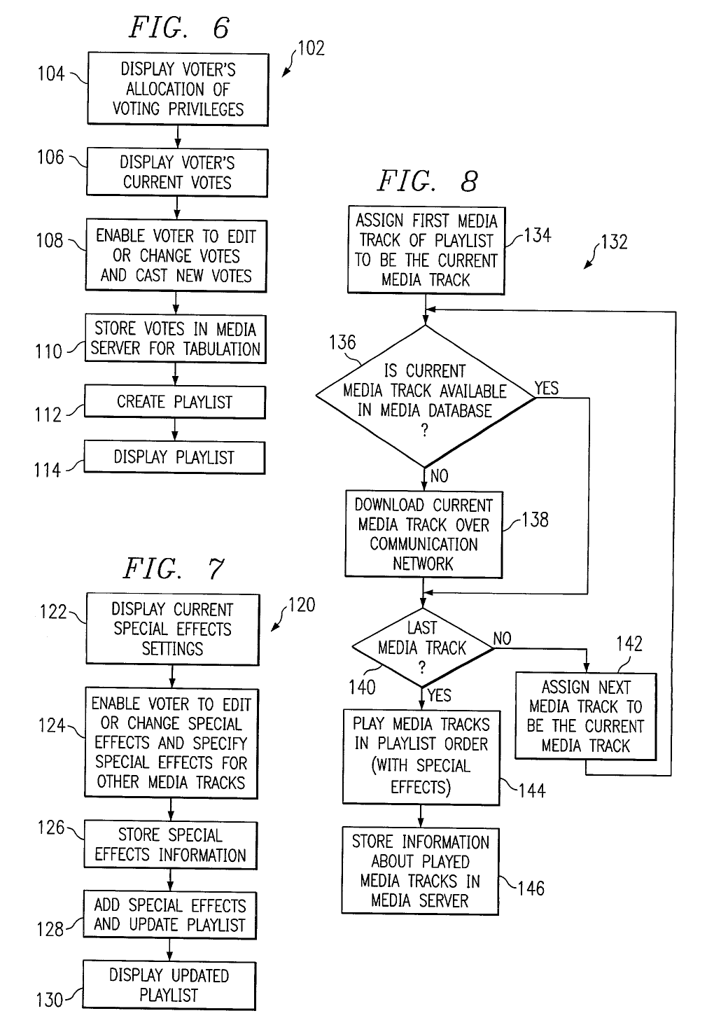

In step 58, media server 12 accepts votes for nominated tracks from the registered voters. In step 60, media server 60 creates a playlist from the nominated tracks based at least in part on votes received from the registered voters. In step 62, the playlist is preferably displayed on display device 24 by media server 12 so that the users may see the order in which different media tracks will be played. The playlist may also be displayed on media terminal 20 and/or wireless device 22. A process of accepting votes for nominated tracks is described in greater detail herein with reference to FIG. 6. In step 64, special effects, if any, may be assigned to the media tracks in the playlist. A process of assigning special effects is described in greater detail herein with reference to FIG. 7. In step 66, media server 12 plays the media tracks in the order of the playlist. A process of playing the media tracks in the order of the playlist is described in greater detail herein with reference to FIG. 8.

FIG. 4 is a flowchart 70 of a method for registering a voter in accordance with an embodiment of the present invention. In step 72, voter information, such as a username, is received from the voter, preferably by user module 40 of media server 12. The voter may enter the information at media terminal 20. In step 74, the voter is authenticated. In this step, authentication information, such as biometric information, for example, voice print, facial image, fingerprint, retinal scan, and/or the like, is received from the user. For example, in order to receive biometric information, user module 40 may prompt the voter to speak specific words into a microphone associated with media terminal 20. The received voice print may then be compared with other voice prints that may be stored in local database 44 of media server 12. If no matches are found, that may indicate that the particular voter has not previously registered under a different username. If desired, other methods may be used to authenticate the voter. Thus, the authentication step preferably prevents the same user from registering multiple times under different names.

In step 76, a password is assigned to the voter, preferably by user module 40. If desired, the voter may be allowed to choose his or her own password or change the assigned password. The voter may log-on to media server 12 utilizing the username and password. If desired, the voter may log-on to media server 12 by utilizing the username and by authenticating herself or himself to media server 12, for example by speaking into the microphone. Voting privileges may also be assigned to the voter in step 76. Voting privileges determine the number of nominations, the number of votes, the time slots, and/or the like, allocated to the voter.

In step 78, a voter card may be generated for the voter. Preferably, the generated voter card is a disposable paper card with a magnetic strip. Preferably, the generated voter card expires at the end of the day or at the end of a specified time period. The advantage of having a voter card is that the voter may simply swipe or scan the voter card on media terminal 20 in order to log-on to media server 20 thereby simplifying the process for the voter. The advantage of having the voter card expire at the end of the day or at the end of a specified time period is that the particular voter to whom the card is assigned cannot pass on the card to others for use on subsequent time periods. The registered voter may obtain a different voter card on subsequent visits with the provider utilizing the group directed media experience system by logging on to media server 12.

In step 80, if desired, the voter's wireless device may be registered with media server 12. Registration of the wireless device with media server 12 enables media server 12 to subsequently identify the voter based on an identification code received from the wireless device. In order to register the voter's wireless device with media server 12, the voter may be prompted to provide information such as, for example, a serial number of the wireless device, a phone number associated with the wireless device, an identification code associated with the wireless device, an identification code associated with the wireless device, a previously assigned password used to provide secure access, and/or the like.

FIG. 5 is a flowchart 84 of a method for accepting nominations from the registered voters in accordance with an embodiment of the present invention. In order to nominate a media track for inclusion in the playlist, the voter may log-on to media server 12, for example by providing username and password. Login module 32 verifies the voter's login information by accessing the voter information as stored in user database 46. Once the voter has logged onto media server 12, in step 86, the voter's allocation of nomination privileges may be displayed to the voter. Nomination privileges may include, for example, the time slots for which the voter may nominate media tracks, any nominations made by but not released by the voter, total number of allocated nominations for the voter, the number of unused allocated nominations for the voter, the weight to be given to the voter's nomination, and/or the like. The media tracks already nominated by the voter may also be displayed (step 88).

In step 90, the voter may edit or change its current nominations and/or nominate new media tracks. The voter may be allowed to browse media tracks by artist name, genre, type of media, “hot” tracks, and/or the like and then nominate media tracks for inclusion in the playlist. “Hot” tracks may include media tracks that are popular nationwide, media tracks that are popular in the particular establishment, media tracks that are popular among members of a particular age group, and/or the like. This and other types of information may be gathered for the voter from other sources, such as by accessing different web sites via the Internet. In step 92, the nominations of the voter are stored in media server 12 along with the nominations of other voters for inclusion in the list of nominations for group voting.

In step 94, the nominated tracks are filtered, preferably by processing module 36, based on at least one criteria to create a nomination list for group voting. The criteria may be the rating of the nominated tracks, the appropriateness of the nominated tracks, the number of nominations received, previous play, and/or the like. For example, a particular track may be filtered out because it is determined that the rating of the track is unsuitable for the group. A particular track may also be filtered out if it has already been played during a predetermined time period immediately preceding the time slot for which nominations are being taken. Furthermore, if the group size is very large, the number of tracks included in the nomination list may be limited to an acceptable number. In that case, the tracks may be filtered based on the number of times a particular track was nominated. If desired, votes of users with greater voting privileges may be given more weight. Thus, for example, in one embodiment a user desiring to have a greater weight be given to his or her vote may purchase additional privileges. The media tracks that are not filtered out are included in the nomination list.

In step 96, the nomination list is displayed on display device 24, preferably by display module 38 of media server 12. A voter may also access the nomination list by logging onto media server 12. Media terminal 20 and/or wireless device 22 may be used for displaying and/or for accessing the nomination list.

FIG. 6 is a flowchart 102 of a method for accepting votes for nominated tracks in accordance with an embodiment of the present invention. In order to vote for media tracks, the voter may log-on to media server 12, for example by providing username and password. Login module 32 verifies the voter's login information by accessing the voter information as stored in user database 46. Once the voter has logged onto media server 12, in step 104, the voter's allocation of voting privileges may be displayed to the voter. Voting privileges may include, for example, the time slots for which the voter may vote, any votes cast but not released by the voter, total number of allocated votes for the voter, the number of unused allocated votes for the voter, the weight to be given to the voter's vote and/or the like. If the voter has already cast votes for the current time slot, then the current votes of the voter may be displayed (step 106).

In step 108, the voter may edit or change its current votes and/or cast new votes. The voter may be allowed to browse through the list of nominated tracks and then cast its vote for the tracks it wants to hear. For any particular time slot, the voter may preferably vote for a plurality of tracks from the nomination list. The number of tracks that a voter may vote for may be predetermined by media server 12. If the number of tracks that a voter may vote for is large, then the time period between the casting of the votes and the playing of the tracks will preferably be longer. In step 110, the votes are stored in media server 12 along with the votes of other voters so that the playlist may be created.

In step 112, the playlist is created preferably by processing module 36 of media server 12. In the preferred embodiment, processing module 36 tabulates the votes cast by all the voters in the group. Preferably, the media tracks with the highest number of votes are selected to be included in the playlist. For example, if the nomination list included 25 media tracks, and the maximum number of media tracks allowed in the playlist is 10, then the 10 media tracks with the highest number of votes are included in the playlist. The order of the media tracks in the playlist is preferably based on the number of votes received by the individual media tracks with the media track with the most votes being number 1. If desired, the order of the media tracks in the playlist may be such that the media track with the most votes is the last media track in the playlist. In such an embodiment, the media tracks may be played as a “count down” to the most-requested media track. If desired, in order to keep the group interested, the playlist could be interspersed with lower-ranked media tracks with the most requested media track being the last one.

In step 114, the playlist is displayed on display device 24, preferably by display module 38 of media server 12. A voter may also access the playlist by logging onto media server 12. Media terminal 20 and/or wireless device 22 may also be used for displaying and/or accessing the playlist.

FIG. 7 is a flowchart 120 of a method for assigning special effects in accordance with an embodiment of the present invention. In order to vote for special effects, the voter may log-on to media server 12, for example by providing username and password. Login module 32 verifies the voter's login information by accessing the voter information as stored in user database 46. Once the voter has logged onto media server 12, the current special effects setting, if any, for the media tracks in the playlist are displayed (step 122), preferably by special effects module 42. The displayed current special effects setting may be the most recent special effects settings selected by the user or the special effects settings most commonly requested by the user. If desired, the user may have a default for special effects setting and the default settings may be displayed.

In step 124, the voter may request a change in the current special effects settings for media tracks and/or specify special effects settings for other media tracks. The voter may browse through the playlist. For those tracks for which special effects settings were not specified by the voter, the voter may specify special effects setting. For those tracks for which special effects setting were already specified by the voter, the voter may, if desired, specify additional settings or modify current settings. For example, the voter may specify the type of lighting, the type of fog, the type of visual effects, and/or the like to accompany the media tracks. The user may specify different settings for different media tracks. In step 126, the special effects information is stored in media server 12 along with the special effects settings of other voters for tabulation. In step 128, special effects module 42 preferably tabulates the special effects for each media track in the playlist based on the input provided by the voters in the group and updates the playlist. Different media tracks may have different special effects associated with them depending on the votes of the users. However, if desired, voters may be allowed to vote for special effects such that the same special effects are applied to all media tracks in the playlist.

In step 130, the updated playlist may be displayed on display device 24, preferably by display module 38 of media server 12. A voter may also access the updated playlist by logging onto media server 12. Media terminal 20 and/or wireless device 22 may be used for displaying and/or accessing the nomination list.

FIG. 8 is a flowchart 132 of a method for playing media tracks in the order of the playlist in accordance with an embodiment of the present invention. In step 134, the first media track listed in the playlist is assigned to be the current media track. In step 136, media database 14 is searched to determine whether the current media track is available in media database 14. If the current media track is not available in media database 14, then in step 138, the current media track is downloaded preferably over communication network 18 from remote media database 16 and execution proceeds to step 140. If, in step 136, it is determined that the current media track is available in media database 14, then execution proceeds directly to step 140.

In step 140, a determination is made as to whether the current media track is the last media track in the playlist. If the current media track is not the last media track in the playlist, then in step 142, the next media track in the playlist is assigned to be the current media track and the process starting at step 136 is repeated.

If in step 140, it is determined that the current media track is the last media track in the playlist, then in step 144, the media tracks are played in the order of the playlist with special effects, if any. In the preferred embodiment, processing module 36 controls the output to audio system 26. Special effects module 42 controls special effects system 28. If desired, the steps of determining whether a media track is available in media database 14 and/or the subsequent downloading of the media track from remote media databases 16 may be executed concurrently with the playing of other media tracks in the playlist.

In step 146, information about the media tracks already played is preferably stored in media server 12. The stored information may include, for example, name of the media track, artist information, date and time the media track was played, and/or the like. The information may be used for various purposes, for example to filter out recently-played media tracks, to create a list of “hot” media tracks, and/or the like.

Embodiments of the present invention may be implemented in software, hardware, or a combination of both software and hardware. The software and/or hardware may reside on media server 12 or be accessible by media server 12.

Although an embodiment of the present invention has been described herein with media server 12 locally residing at an establishment or with a provider, the invention is not so limited and in alternative embodiments, media server 12 may be at a remote location and remotely accessed by media terminal 20 and/or wireless device 22.

Although an embodiment of the present invention has been described above with different modules performing different operations, the invention is not so limited. One or more of the above described modules may be combined without departing from the scope of the present invention. Furthermore, although the present invention has been described above with different databases storing different types of information, the invention is not so limited. One or more of the above described databases may be combined without departing from the scope of the present invention.

If desired, the different steps discussed herein may be performed in any order and/or concurrently with each other. Furthermore, if desired, one or more of the above described steps may be optional or may be combined without departing from the scope of the present invention.

An advantage of the preferred embodiment of the present invention is that the playlist is created based in part on the selection of the group. Thus, the media tracks played are more likely to be enjoyed by the majority of the group, then if a single person, for example a disc jockey, was selecting the media tracks. Moreover, because the media server can access media tracks from remote locations, a wider selection of media tracks is available to the voters. Another advantage of a preferred embodiment of the present invention is that a user may easily sample, experience and/or purchase media content. Furthermore, the user may be made aware of media events of interest to the user.

What is claimed is:

1. A method for a media experience directed by a group, comprising:
receiving input from a plurality of members of said group regarding a plurality of media content;
creating a playlist of media content based at least in part on said received input; and
playing said media content in the order in which said media content appear in said playlist.

2. The method of claim 1, further comprising registering at least one of said plurality of members prior to said receiving step.

3. The method of claim 1, further comprising registering at least one member by receiving information from said at least one member.

4. The method of claim 1, further comprising registering a wireless device of at least one of said plurality of members.

5. The method of claim 1, wherein receiving input comprises receiving nominations for selected ones of said plurality of media content from said plurality of members.

6. The method of claim 5, further comprising tracking past nominations of at least one of said plurality of members.

7. The method of claim 5, wherein receiving nominations comprises receiving nominations from said plurality of members based at least in part on a nomination privilege of said plurality of members.

8. The method of claim 7, wherein for each of said plurality of members said nomination privilege is selected from the group consisting of a time slot for which said member is permitted to nominate media content, total number of allocated nominations for said member, nominations made by but not released by said member, number of unused allocated nominations for said member and a weight to be given to said member's nomination.

9. The method of claim 1, further comprising allowing selected ones of said plurality of members to provide nominations only from a media database and selected other ones of said plurality of members to provide nominations from a plurality of remote media databases in addition to said media database based at least in part on a member status.

10. The method of claim 1, further comprising creating a nomination list from said plurality of media content.

11. The method of claim 5, further comprising filtering said received nominations based on at least one criteria to create a nomination list.

12. The method of claim 1, further comprising displaying a nomination list on a display device.

13. The method of claim 1, wherein receiving input comprises receiving votes for selected ones of said plurality of media content from said plurality of members for inclusion in said playlist.

14. The method of claim 13, further comprising tracking past votes of at least one of said plurality of members.

15. The method of claim 1, further comprising preventing at least one of said plurality of members from voting multiple times for a particular time slot.

16. The method of claim 13, further comprising displaying past votes of at least one of said plurality of members in response to a request from said at least one member.

17. The method of claim 13, further comprising creating a set of preferences for at least one of said plurality of members based at least in part on past votes of said at least one member.

18. The method of claim 17, further comprising suggesting media content to said at least one member based at least in part on said set of preferences.

19. The method of claim 13, wherein receiving votes comprises receiving votes from said plurality of members based at least in part on a voting privilege of said plurality of members.

20. The method of claim 19, wherein for each of said plurality of members said voting privilege is selected from the group consisting of a time slot for which said member is permitted to vote for media content, total number of allocated votes for said member, votes cast but not released by said member, number of unused allocated votes for said member and a weight to be given to said member's vote.

21. The method of claim 13, further comprising allowing at least one of said plurality of members to change its current votes.

22. The method of claim 13, further comprising:
allowing at least one of said plurality of members to browse a nomination list; and
receiving votes from said at least one member for at least one media track in said nomination list.

23. The method of claim 1, wherein creating said playlist comprises selecting a predetermined number of media content from said plurality of media content for inclusion in said playlist.

24. The method of claim 1, wherein creating said playlist comprises selecting a predetermined number of media content based at least in part on a number of votes received for each of said plurality of media content.

25. The method of claim 1, further comprising displaying said playlist on a display device.

26. The method of claim 1, further comprising determining the availability of said media content of said playlist in a local database of a media server.

27. The method of claim 1, further comprising downloading at least one of said media content of said playlist from a remote database in response to said at least one media content not being available in a local database.

28. The method of claim 1, further comprising storing information about said played media content in a media server.

29. The method of claim 1, further comprising assigning special effects to at least one of said media content in said playlist based at least in part on input from at least one of said plurality of registered members.

30. The method of claim 1, further comprising authenticating at least one member of said plurality of members.

31. The method of claim 1, further comprising receiving biometric information from at least one of said plurality of members to authenticate said member.

32. The method of claim 31, wherein said receiving biometric information comprises receiving biometric information selected from the group consisting of a voice print of said at least one member, a fingerprint of said at least one member, a facial image of said at least one member, and a retinal image of said at least one member, to authenticate said member.

33. The method of claim 1, further comprising providing a media terminal comprising a biometric input receiver, said biometric input receiver operable to receive biometric information from at least one of said plurality of members.

34. The method of claim 33, wherein said providing said media terminal comprises providing said biometric input receiver selected from the group consisting of a microphone, a fingerprint scanner, a video camera, and a retinal scanner.

35. The method of claim 1, further comprising assigning a password to at least one member of said plurality of members.

36. A media server for a group directed media experience, comprising a processing module operable to automatically create a playlist of media content from a plurality of media content based at least in part on selection by a plurality of members of said group, said processing module further operable to play said media content in said playlist.

37. The media server of claim 36, further comprising a user database operable to store information about at least one of said plurality of members.

38. The media server of claim 37, wherein said information comprises information selected from the group consisting of a user ID of said at least one member, a name of said at least one member, password information, biometric information of said at least one member, status of said at least one member, email address of said at least one member, last login information of said at least one member, a preference of said at least one member, nomination records of said at least one member, voting records of said at least one member, and credit card number of said at least one member.

39. The media server of claim 36, further comprising a media database coupled to said processing module, said media database for storing a plurality of media content.

40. The media server of claim 39, further comprising a download module operable to download at least one media content of said playlist from a remote database in response to said at least one media content not being available in said media database.

41. The media server of claim 40, wherein said remote database comprises a private collection of media content of at least one of said plurality of members.

42. The media server of claim 36, further comprising a download module operable to download additional information on at least one media content of said plurality of media content in response to a request from at least one member of said plurality of members.

43. The media server of claim 36, said processing module further operable to create a nomination list of media content from said plurality of media content selected by at least one member of said group based at least in part on predefined criteria.

44. The media server of claim 36, further comprising a special effects module operable to interface with a special effects system.

45. The media server of claim 36, said processing module further operable to retrieve information on media content selected by at least one of said plurality of members based at least in part on at least one search criteria provided by said at least one member.

46. The media server of claim 36, said processing module further operable to register at least one of said plurality of members.

47. The media server of claim 36, said processing module further operable to accept nominations from said plurality of members for inclusion in a nomination list.
